(19) United States
(12) Patent Application Publication
(10) Pub. No.: US 2003/0168268 A1
(43) Pub. Date: Sep. 11, 2003

(54) Vehicular accessory device

(76) Inventor: Brian Oliver, San Antonio, TX (US)

Correspondence Address: Attn: Janice Leverett, Soules & Wallace, P.C., Frost Bank Tower, 100 W. Houston St., Ste. 1500, San Antonio, TX, 78205, US

(21) Appl. No.: 10/092,017

(22) Filed: Mar. 6, 2002

(51) Int. Cl. B60K 13/02

(52) U.S. Cl. 180/68.3

(57) ABSTRACT

A vehicular accessory device, namely automotive grills, designed to be positioned onto a front end of a car. Specifically, the automotive grill includes a filter system having at least one portal and a plurality of apertures bored therethrough to permit air flow. The portal is capable of receiving a first end of an airflow conduit and channeling air to an engine compartment. A bottom portion of the grill is adapted to sit in a recess of the car and a top portion is mounted underneath fog lights.

In an embodiment, a periphery of an entrance of the induction system is surrounded by a piece of material in order to create a seal. A recess may also be included at each distal end of the filter system in order to adapt to the front end of the vehicle. Further, the filter system is capable of incorporating at least one fastening member being mounted thereon.

### TECHNICAL FIELD

The present invention relates to a vehicular accessory device, namely a grill, positioned on a front end of a vehicle. In particular, this invention relates to an automotive grill used to prevent damage and enhance air flow to the vehicle.

### BACKGROUND OF THE INVENTION

The usage of vehicle grills is known in the art, particularly in the automotive accessory industry. In the past, some manufacturers had begun attaching an accessory, called a grill, to the front end of the vehicle. Traditionally, the grill was bent in various areas in order to conform to the contour of the vehicle in order to protect the exterior of the automobile.

Most vehicles today increasingly include a grill not only to enhance the aesthetic appeal of the vehicle, but to also promote air circulation into a vehicle's engine. Due to the dual purpose the grill, this device has become more popular to the consuming public, manufacturers and sellers and are now well known in the art.

Currently, several grills are made from a thin plate made of injected plastic material having multiple holes to allow for air flow to the engine. Other grills have included mesh of woven metallic threads joined to a perimetral frame for added stability. However, these metallic mesh grills were too expensive to produce thereby causing many consumers, manufacturers or sellers to eliminate the use of the grill altogether.

Therefore, several attempts have been made to redesign such grills in order to reduce costs and become more user-friendly. An example of such device is shown in U.S. Pat. No. Re. 34,907 (“'907 patent”) issued to Gross in Apr. 18, 1995. The '907 patent provides for a grill mounted on a motor vehicle having multiple separate panel elements. Each panel is capable of being clipped onto the front grill by a spring clip adhesively attached to the rear face of the panel element. Further, the grill has recesses at openings therethrough with structural members across the recesses at a position recessed from the front face of the grill.

However, as technology advanced, many improvements were made to the grill such as functionality, materials and configurations. An example of such an improvement to functionality is seen in U.S. Pat. No. 5,988,840 (“'840 patent”) issued to Wirtz in 1999. The '840 patent described a replacement grill having slidable headlight covers designed for vehicles. The grill includes a frame with a grillwork to allow airflow into the engine compartment. Here, the headlight covers are slidably mounted within the frame for movement between open and closed positions.

An example of improved materials is depicted in U.S. Pat. No. 6,206,438 (“'438 patent”) issued to Pueyo in 2001. The '438 patent provides for a grill having a plastic mesh like area designed to visually appear like a metallic wire mesh grill. Here, the grill, being formed by injection molding, is made of a longitudinal set of first thread members and a transversal set of second thread member are joined to each other at several intersection points.

Lastly, an example of a grill having an improved configuration is shown in U.S. Pat. No. 6,279,468 (“'468 patent”) issued to Webster in 2001. The '468 patent describes a grill rolled into 20 a substantially cylindrical shape with integral fold-up support frame having a first end frame member attached laterally to a first end of a grill surface and a second end frame member attached laterally to a second end of the flexible grill surface. However, like the abovementioned prior art, this patent also fails to incorporate an airflow conduit mated to the grill in order to increase the amount of air received for superior ventilation.

In view of the above deficiencies associated with the use of grill devices, the present invention has been developed to alleviate these drawbacks and provide further benefits to the user as a whole. These enhancements and benefits are described in greater detail herein below with respect to several alternative embodiments of the present invention.

### SUMMARY OF THE INVENTION

The present invention in its several disclosed embodiments alleviates the drawbacks described above with respect to vehicular accessory devices, namely automotive grills and incorporates several additionally beneficial features. The present invention is an automotive grill incorporating a screen having at least one portal and a plurality of apertures bored therethrough. Each portal is capable of receiving a first end of an airflow conduit and channeling received air to critical parts of an engine compartment. Further, the plurality of apertures allows air to flow into and through the filter system and enter the engine intake compartment, namely the fuel injection system.

In an embodiment, a periphery of an entrance of the induction system is surrounded by a piece of material in order to create a seal. A recess may also be included at each distal end of the screen in order to adapt to the front end of the vehicle. Further, the screen is capable of incorporating at least one fastening member being mounted thereon.

It is therefore a goal of the present invention to prevent damage to a vehicle, particularly to the engine compartment, by providing a filter system such as a screen capable of blocking rocks, road debris and the like from entering and directly accessing the compartment. The screen includes a plurality of apertures allowing air to filter through and into the interior of the engine compartment.

Another advantage of the present invention is to provide for a vehicular grill having at least one airflow conduit to aid in providing necessary air circulation in order to appropriately cool down the engine compartment. Preferably, the airflow conduits are centered on the screen to provide for uniform air intake. Further, the placement of the airflow conduits may be customized according to a particular make and model of the vehicle. Moreover, a piece of material is adapted to cover the periphery of an entrance of the induction system in order to create an airtight seal and further the airflow circulation.

Aside from the functional aspects of the present invention, a further advantage of the present invention is to provide for a grill being aesthetically appealing. The grill may be customized to fit the configuration and color of specific vehicles. Specifically, the grill may include a recess on each opposing side in order to accommodate structures, such as headlights, located on the front portion of the vehicle. Further, the grill is capable of incorporating at least one fastening member to mount and provide stability of the screen to the vehicle. The present invention may be utilized for commercial or residential uses and is easy to manufacture.

Further advantages of the invention will be more clearly understood from the following description of illustrative embodiments thereof, to be read by way of example and not of limitation in conjunction with the apparatus shown in the accompanying drawings.

### BRIEF DESCRIPTION OF THE DRAWINGS

The invention will now be described in greater detail in the following way of example only and with reference to the attached drawings, in which:

FIG. 1 is a front view of a vehicle showing placement of a vehicular accessory device.

FIG. 2 is a front view of the vehicular accessory device having a plurality of apertures bored therethrough and air lines.

FIG. 3 is a top perspective view of the vehicular accessory device depicting one end of each air line being connected to the device.

FIG. 4 shows a front view of the vehicular accessory device having an alternative configuration.

FIG. 5 depicts a top perspective view of the vehicular accessory device having an alternative configuration.

FIG. 6 is a schematic view of the air lines being operatively connected to an engine portion of the vehicle.

FIG. 7 is another schematic view of the air lines being mated to an alternative engine portion of a vehicle.

FIG. 8 is a front view of the vehicular accessory device incorporating a recess at each opposing end of the device.

### MODE(S) FOR CARRYING OUT THE INVENTION:

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

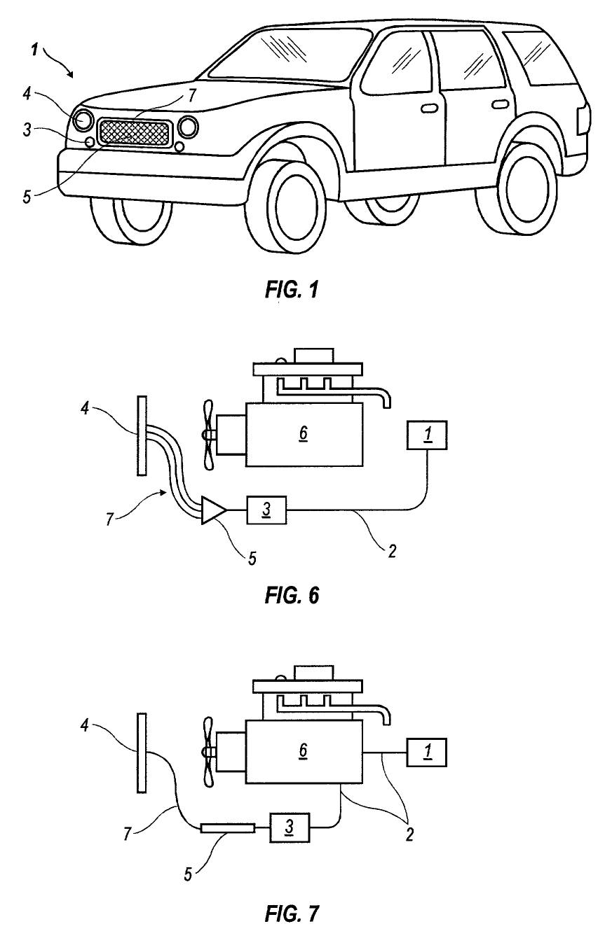

FIG. 1 depicts a vehicular accessory device 5, preferably having an elongated and unitary structure, being positioned on a front end 1 of a vehicle. The vehicular accessory device 5 may be bordered by a frame adapted to be secured onto the vehicle by at least one fastener. In a preferred embodiment, the accessory device 5 is mounted into and sits inside a recess 7. In particular, a bottom portion of the grill is adapted to sit in a recess of the car and a top portion is mounted underneath fog lights. Specifically, on most vehicles, the recess 7 is located between a fog lighting system 3 and head lights 4 of the vehicle. Alternatively, the recess 7 may either be positioned underneath the fog lighting system 3; or in the event a vehicle does not utilize a fog lighting system 3, the recess 7 is located underneath the head lights 4.

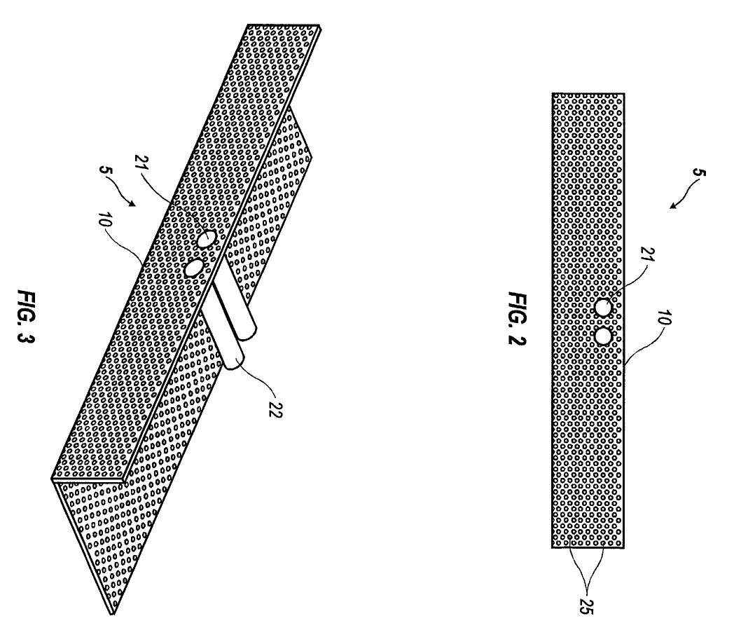

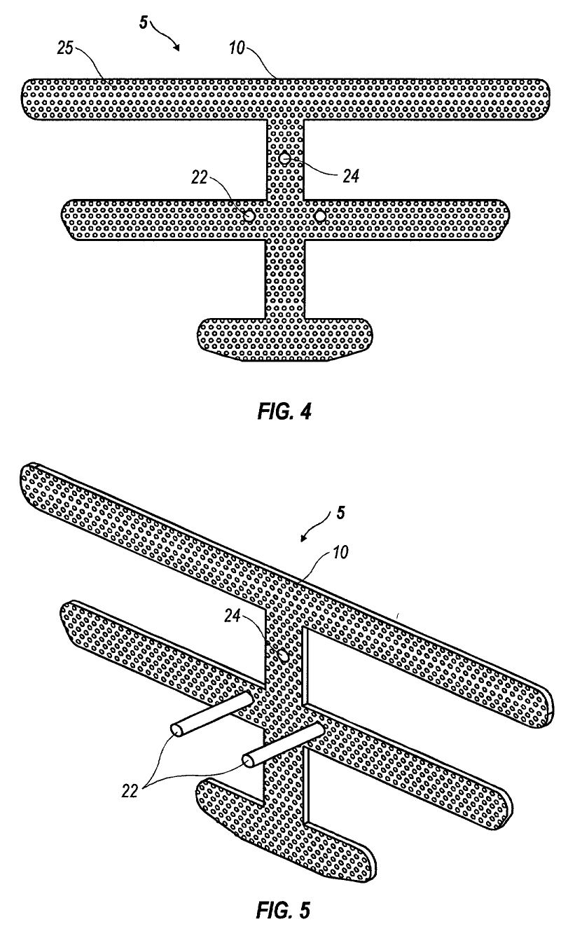

FIGS. 2 and 4 depict the vehicular accessory device 5, namely an automotive grill, collectively including a filter system 10 having a plurality of apertures 25 and at least one portal 21 bored therethrough. The plurality of apertures 25 allows air to enter into and through the filter system 10 and flow into an engine compartment 27, specifically a fuel injection system, a carborator system or other system incorporated within or positioned near an engine area. Each aperture 25 is sized small enough to prevent foreign objects such as rocks, road debris and the like from passing into and through the filter system 10 and coming into direct contact with the engine compartment 27 of the vehicle. The plurality of apertures 25 is preferably disposed throughout the entire area of the filter system 10 thereby allowing uninterrupted air ventilation to occur.

FIGS. 3 and 5 show each portal 21 being operatively mounted, preferably pressed fit, to and capable of receiving a first end of an airflow conduit 22. Each portal 21 may be centrally located or positioned on a side of the filter system 10; or alternatively, each portal 21 may be distally opposed to one another. In a preferred embodiment, multiple portals 21 are linearly positioned on the filter system 10 providing for substantially enhanced air intake. Specifically, these portals 21 are sized to enhance greater air flow intake. The second end of each airflow conduit 22 is fastened to an entrance of the induction system 36. In a preferred embodiment, each airflow conduit 22 is oriented parallel to each other; and the periphery of the entrance of the induction system 36 is surrounded by a piece of rigid polystyrene plastic or other durable material thereby creating an impervious seal and providing a fixed attachment thereto. Each airflow conduit 22 desirably has a tubular configuration made of, but not limited to, plastic material. The length of each airflow conduit 22 varies according to the make and model of a particular vehicle.

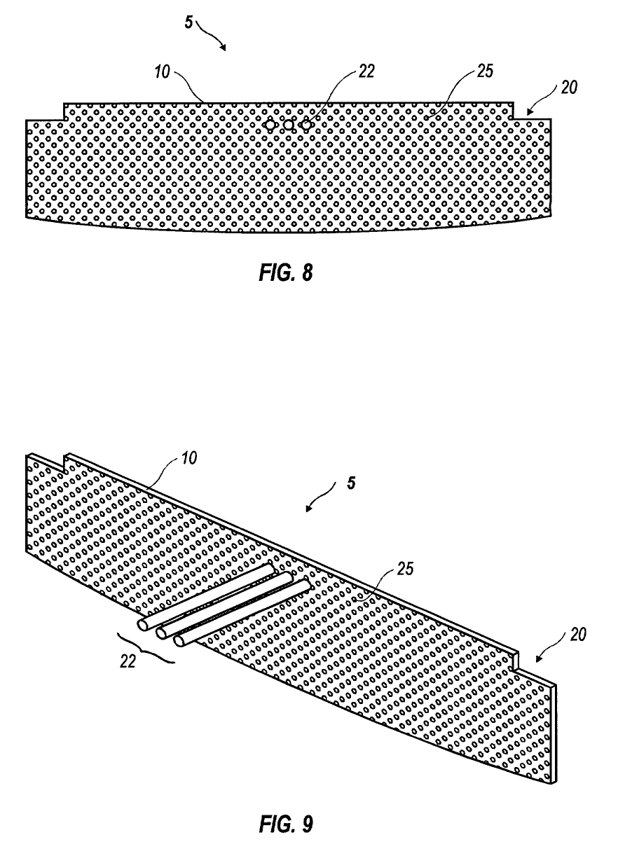

In an embodiment, as shown in FIG. 8, each distal end of the filter system 10, either on a top or bottom portion of the system 10, incorporates a recess 20 designed to accommodate the structure of the front end of the vehicle, such as the position of the fog lights 3 or head lights 4. These recesses 20 vary in size due to the contour of the front end of the vehicle along with the size of the fog lights 3 or head lights 4.

Preferably, the filter system 10 is made of steel, wire mesh or other durable material capable of withstanding damage. The filter system 10 may have variable configurations, where each configuration is adapted to a specific vehicle. FIG. 4 specifically shows an alternative configuration where the filter system 10 includes a slot 24 allowing for a fastener to be introduced therein. In an embodiment, the filter system 10 may include at least one fastening member 44 being orthogonally attached thereto and protruding outwardly. In a preferred embodiment, each fastening member 44 magnetically connects the filter system 10 to the front end of the vehicle. Alternatively, the fastening member 44 may be an L-clip where the vertical portion of the clip is mounted flush to an interior portion of the filter system 10; and the horizontal portion of the clip perpendicularly extends from the filter system 10 to the front end of the vehicle.

FIGS. 6 and 7 depict schematic views of each airflow conduit 22 being mated to an engine portion of the vehicle. Operatively speaking, air enters the filter system 10 via its apertures 15 and is channeled into and through airflow conduit 22 accessing the entrance of the induction system 36. The air flow is filtered through an air cleaner 34 and into an induction line 32. The induction line 32 perpendicularly extends and is force fed into the fuel injection system 30 where air is ultimately released. Alternatively, the induction line 32 extends through a motor 39 and orthogonally terminates at the fuel injection system 30. The more air flow permitted to enter and run throughout the engine portion 39, the smoother the vehicle runs.

Whereas the invention has been shown and described in connection with the preferred embodiments thereof, it will be understood that many modifications, substitutions, and additions may be made which are within the intended broad scope of the following claims. From the foregoing, it can be seen that the present invention accomplishes at least all of the stated objectives.

### INDUSTRIAL APPLICABILITY

The present invention finds specific industrial applicability in the automotive and vehicular accessories industry.

What is claimed and desired to be secured by Letters Patent is as follows:

1. A vehicular accessory device designed to be mounted on a front end of a vehicle comprising:
a filter system having at least one portal bored therethrough; and
at least one airflow conduit having an end being receivingly coupled to said portal.

2. The vehicular accessory device as recited in claim 1, wherein said filter system further comprises: a plurality of apertures bored therethrough allowing air to enter through said filter system and into an engine compartment.

3. The vehicular accessory device as recited in claim 2, wherein said plurality of apertures being substantially disposed throughout an area of said filter system.

4. The vehicular accessory device as recited in claim 1, wherein said airflow conduit having a second end operatively mated to an interior portion of a vehicle.

5. The vehicular accessory device as recited in claim 4, wherein said interior portion of a vehicle is an entrance to an induction system.

6. The vehicular accessory device as recited in claim 1, wherein said portal is centrally positioned through said filter system.

7. The vehicular accessory device as recited in claim 1, wherein said portal is positioned on a side of said filter system.

8. The vehicular accessory device as recited in claim 1, wherein each of said portals is opposingly located to one another.

9. The vehicular accessory device as recited in claim 1, further comprising multiple portals being linearly positioned on said filter system.

10. The vehicular accessory device as recited in claim 1, further comprising a piece of material peripherally surrounding said entrance of the induction system to create an impervious seal.

11. The vehicular accessory device as recited in claim 10, wherein said piece of material is made of polystyrene plastic.

12. The vehicular accessory device as recited in claim 1, wherein said filter system has a recess incorporated on each distal end of said filter system in order to accommodate said front end of said vehicle.

13. The vehicular accessory device as recited in claim 1, wherein said filter system is made of material consisting of steel or wire mesh.

14. The vehicular accessory device as recited in claim 1, wherein said screen has a slot allowing for a fastener to be introduced therein.

15. The vehicular accessory device as recited in claim 1, wherein said screen has at least one fastening member being perpendicularly fastened thereto and extending outwardly.

16. The vehicular accessory device as recited in claim 15, wherein said fastening member is selected from the group consisting of an L-clip, magnet, screw, epoxy glue, clip, press fitting and welded material connected to said filter system.

17. The vehicular accessory device as recited in claim 1, wherein said filter system is peripherally bordered by a frame, said frame capable of being secured onto said vehicle by at least one fastener.

18. The vehicular accessory device as recited in claim 1, wherein said filter system sits inside a recess located on said front end of said vehicle.
